(19) United States
(12) Patent Application Publication
(10) Pub. No.: US 2013/0278497 A1
(43) Pub. Date: Oct. 24, 2013

(54) VIRTUAL IMAGE DISPLAY APPARATUS

(71) Applicant: SEIKO EPSON CORPORATION, (US)

(72) Inventors: Masayuki TAKAGI, Shiojiri-shi (JP); Takahiro TOTANI, Suwa-shi (JP); Takashi TAKEDA, Suwa-shi (JP); Akira KOMATSU, Kamiina-gun (JP); Toshiaki MIYAO, Matsumoto-shi (JP)

(73) Assignee: SEIKO EPSON CORPORATION, Tokyo (JP)

(21) Appl. No.: 13/860,840

(22) Filed: Apr. 11, 2013

(30) Foreign Application Priority Data
Apr. 23, 2012 (JP) 2012-097421

(51) Int. Cl. G06F 3/01

(52) U.S. Cl. CPC G06F 3/012
USPC 345/156

(57) ABSTRACT

An attitude information detection unit detects the attitude of a wearer, and an arithmetic processing unit and a device position drive unit, which form an image area position adjustment mechanism, translate a liquid crystal display device that is a light modulating device relative to a light guide section in a plane parallel to a light incident surface of the light guide section based on a detection result from the attitude information detection unit, whereby the position of an image area can be so changed that an image moves in the direction opposite the direction in which the wearer moves. As a result, when the wearer moves, the image does not follow the motion of the wearer as if the image remained still, whereby the wearer who moves will have a reduced amount of unpleasant sensation resulting from the motion.

### BACKGROUND

1. Technical Field

The present invention relates to a virtual image display apparatus, such as a head-mounted display worn around the head for use.

2. Related Art

In recent years, as a virtual image display apparatus capable of formation and observation of a virtual image, such as a head-mounted display, various types of apparatus in which image light from a display device is guided to the pupils of a wearer who is a viewer have been proposed. For example, to superimpose the image light that forms a virtual image on environment light that is light from the environment, a see-through-type apparatus has been proposed (see JP-A-2012-3040).

An image projected by a head-mounted display moves as the wearer moves. For example, in the case of the see-through-type apparatus described above, when the wearer who wears the apparatus and sees an environment light image formed by environment light moves the neck or any other part of the body to change the direction of the line of sight of the wearer, part of the environment light image goes out of sight of the wearer, whereas the virtual image formed by the image light follows the motion of the wearer and does not go out of sight of the wearer. The situation in which an image always follows motion of the wearer may cause a very uncomfortable sensation of the wearer in some cases. Some wearers may even develop motion-sickness-like symptoms. In the case of an apparatus that is worn around the head of a wearer and allows the wearer to view an image, such as a head-mounted display, it is inevitable that the wearer moves the head (neck), that is, the wearer changes the attitude. The uncomfortable sensation resulting from such motion also occurs with a non-see-through-type head-mounted display that blocks environment light.

### SUMMARY

An advantage of some aspects of the invention is to provide a virtual image display apparatus that adjusts the position of an image area in accordance with a change in attitude of a wearer to reduce the amount of uncomfortable sensation felt by the wearer resulting from the way in which a virtual image is displayed.

A virtual image display apparatus according to an aspect of the invention includes (a) a virtual image formation unit that forms a virtual image from image light, (b) an attitude information detection unit that detects a change in attitude of the head of a wearer who views the virtual image, and (c) an image area position adjustment mechanism that adjusts an image area position of an image formed of the virtual image formed by the virtual image formation unit based on a detection result from the attitude information detection unit in such a way that the image area position changes in a direction opposite the direction in which the wearer changes the attitude. It is assumed that the image area where an image to be formed of a virtual image is displayed is, for example, present in a plane in front of the wearer, and that a position on an axis that extends in a direction perpendicular to the front plane and passes through the center of an eye of the wearer is used as a reference position of the center of the image area where the image is displayed.

In the virtual image display apparatus, the attitude information detection unit can detect a change in the attitude of a wearer, and the image area position adjustment mechanism can make a correction in which the image area position is changed in such a way that the image moves in the direction opposite the direction in which the wearer moves, that is, can perform counter correction control based on the detection results of the attitude information detection unit. The control allows the wearer who moves to recognize that the image does not follow the motion of the wearer as if the image remained still, whereby the wearer who moves will have a reduced amount of unpleasant sensation resulting from the motion.

In a specific aspect of the invention, (a) the virtual image formation unit includes (a1) a light modulating device that modulates illumination light from a light source to form image light, (a2) a projection system that projects the image light from the light modulating device, and (a3) a light guide section that guides the image light from the projection system and outputs the image light to form the virtual image formed by the image light, and (b) the image area position adjustment mechanism is a movement control mechanism that controls movement of at least one of the light modulating device, the projection system, and the light guide section. In this case, the image area position adjustment mechanism works as the movement control mechanism and moves any of the light modulating device, the projection system, and the light guide section, whereby the image area position can be changed.

In another aspect of the invention, the image area position adjustment mechanism is a movement control mechanism that moves the light modulating device relative to the light guide section in a plane parallel to a light incident surface of the light guide section. In this case, the light modulating device is moved relative to the light guide section, whereby the image area position can be adjusted.

In still another aspect of the invention, the image area position adjustment mechanism is a movement control mechanism that moves the projection system relative to the light guide section in a plane parallel to a light incident surface of the light guide section. In this case, the projection system is moved relative to the light guide section, whereby the image area position can be adjusted.

In still another aspect of the invention, the image area position adjustment mechanism is a movement control mechanism that rotates the light modulating device and the projection system as a unitary member to incline a projection optical axis of the projection system with respect to a light incident surface of the light guide section. In this case, the position of the image area to be formed can be adjusted by adjusting the direction of the projection optical axis of the projection system.

In still another aspect of the invention, the image area position adjustment mechanism is a modulation control mechanism that controls modulation operation of the light modulating device. In this case, the image area position can be adjusted by controlling the modulation operation.

In still another aspect of the invention, the image area position adjustment mechanism is a movement control mechanism that rotates the entire virtual image formation unit. In this case, the image area position can be adjusted by moving the entire virtual image formation unit.

In still another aspect of the invention, (a) the virtual image formation unit includes (a1) a signal light modulation portion that outputs signal light modulated in accordance with an image, (a2) a scan system that scans the modulated signal light and outputs the scanned light, and (a3) an irradiated member that receives the scanned light from the scan system to form the virtual image formed by the image light, and (b) the image area position adjustment mechanism is a mechanism that adjusts an irradiation angle of the scanned light from the scan system. In this case, the irradiated member forms a virtual image and the image area position adjustment mechanism adjusts the irradiation angle of the scanned light from the scan system, whereby the image area position can be adjusted.

In still another aspect of the invention, the virtual image formation unit transmits environment light and superimposes an environment light image formed by the environment light on the virtual image formed by the image light. In this case, see-through observation can be made.

In still another specific aspect of the invention, the virtual image formation unit covers part of a portion in front of an eye of the wearer. In this case, the overall size of the apparatus can be reduced, and the wearer can view the environment through a portion around the virtual image formation unit.

### BRIEF DESCRIPTION OF THE DRAWINGS

The invention will be described with reference to the accompanying drawings, wherein like numbers reference like elements.

FIG. 1 is a perspective view showing a virtual image display apparatus according to a first embodiment.

FIG. 2A is a plan cross-sectional view of a main body of a first display apparatus that forms the virtual image display apparatus, and FIG. 2B is a front view of the main body.

FIG. 3 is a plan view for describing an exemplary specific optical path in the optical system of the virtual image display apparatus.

FIG. 4A describes image position adjustment in the virtual image display apparatus, FIG. 4B shows image shift in the right-left direction, and FIG. 4C shows image shift in the up-down direction.

FIG. 5 describes adjustment operation in the right-left direction in the virtual image display apparatus.

FIG. 6A is a plan view for describing a virtual image display apparatus according to a second embodiment, and FIG. 613 shows image shift.

FIG. 7A is a plan view for describing a virtual image display apparatus according to a third embodiment, FIG. 7B shows image shift in one of the rightward and leftward directions, and FIG. 7C shows image shift in the other one of the rightward and leftward directions.

FIG. 8A is a plan view for describing a virtual image display apparatus according to a fourth embodiment, and FIG. 8B describes adjustment operation made by an image area position adjustment mechanism.

FIG. 9A is a plan view for describing a virtual image display apparatus according to a fifth embodiment, and FIG. 9B describes adjustment operation made by an image area position adjustment mechanism.

FIG. 10A is a plan view for describing a virtual image display apparatus according to a sixth embodiment, and FIG. 10B describes adjustment operation made by an image area position adjustment mechanism.

FIG. 11A is a plan view for describing a virtual image display apparatus according to a seventh embodiment, and FIG. 11B describes adjustment operation made by an image area position adjustment mechanism.

FIG. 12 shows a virtual image display apparatus according to an eighth embodiment.

FIG. 13 shows an example of another virtual image display apparatus.

FIG. 14 shows an example of another virtual image display apparatus.

### DESCRIPTION OF EXEMPLARY EMBODIMENTS

### First Embodiment

A virtual image display apparatus according to a first embodiment of the invention will be described below in detail with reference to the drawings.

### A. Exterior Appearance of Virtual Image Display Apparatus

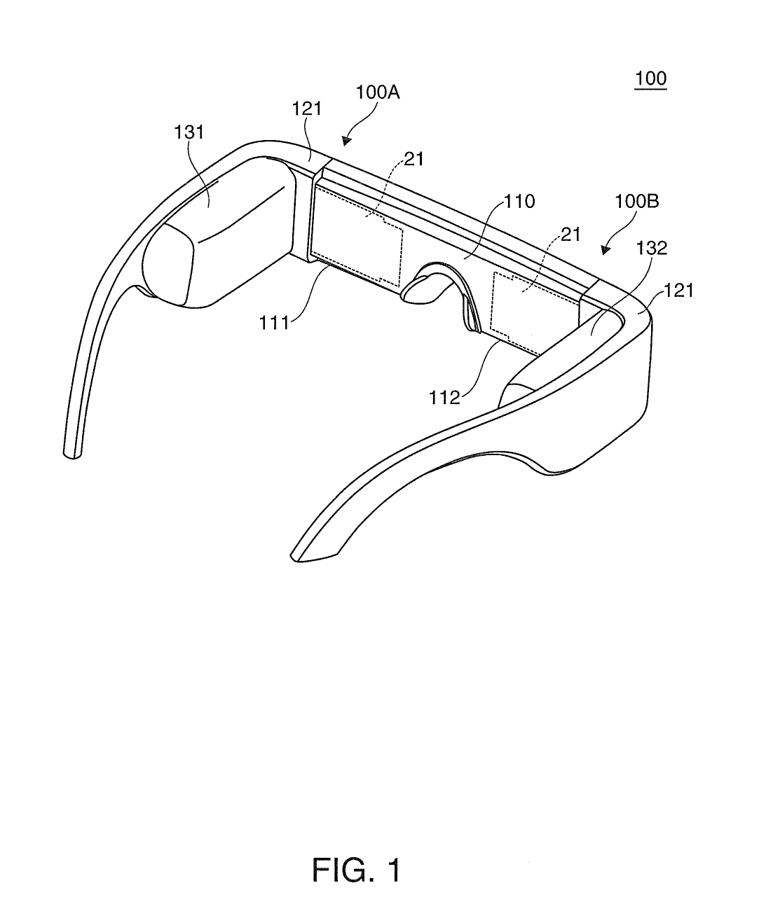

A virtual image display apparatus 100 according to the present embodiment shown in FIG. 1, which is a head-mounted display having a spectacle-like external appearance, allows a wearer, a viewer wearing the virtual image display apparatus 100, not only to recognize image light in the form of a virtual image but also to view an environment light image in see-through observation. The virtual image display apparatus 100 includes an optical panel 110, which covers a portion in front of the eyes of the wearer, frames 121, which support the optical panel 110 and other components, and first and second drivers 131, 132, each of which is attached to a portion of the corresponding frame 121 that extends from a front-side cover portion to a temple. The optical panel 110 includes a first panel portion 111 and a second panel portion 112, and the two panel portions 111 and 112 are connected to each other at the center of the optical panel 110 to form an integrated plate-shaped part. A first display apparatus 100A, which is a combination of the first panel portion 111 and the first driver 131 on the left side in FIG. 1, is a unit that forms a virtual image for the left eye and functions as a virtual image display apparatus alone. Similarly, a second display apparatus 100B, which is a combination of the second panel portion 112 and the second driver 132 on the right side in FIG. 1, is a unit that forms a virtual image for the right eye and functions as a virtual image display apparatus alone.

### B. Structure of Display Apparatus

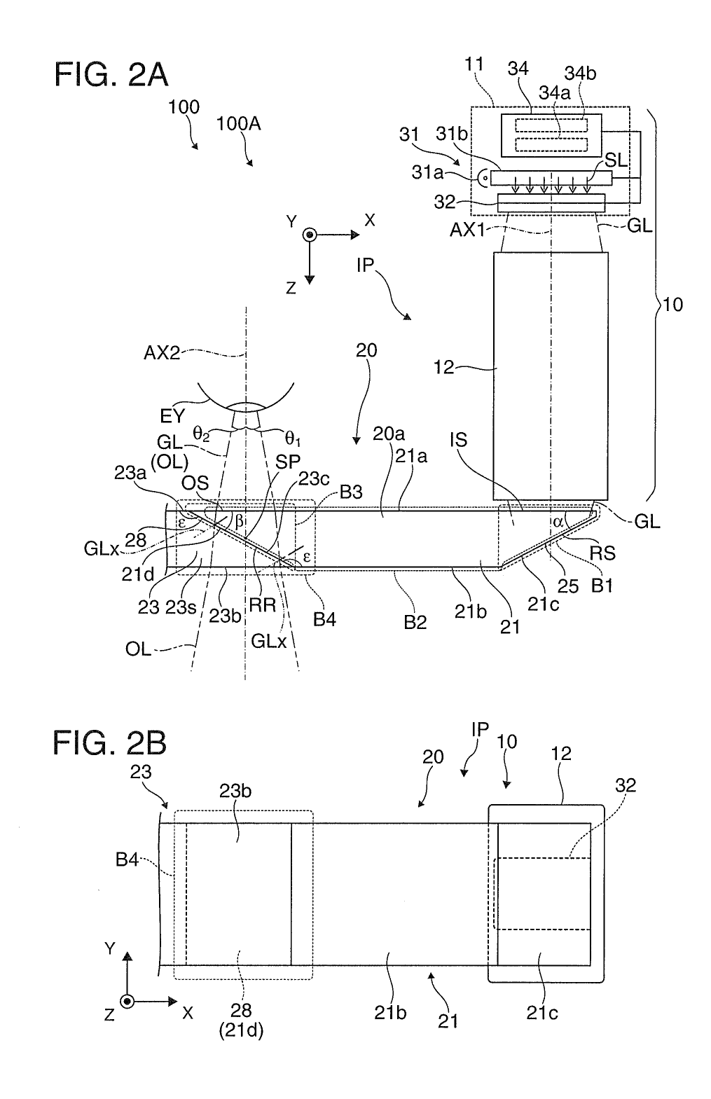

The structure of the first display apparatus 100A, that is, a main body of the display apparatus will be described below with reference to FIG. 2A and other figures.

The first display apparatus 100A includes an image formation section 10 and a light guide section 20, as shown in FIGS. 2A and 2B. The image formation section 10 corresponds to the first driver 131 in FIG. 1, and the light guide section 20 corresponds to the first panel portion 111 in FIG. 1. The second display apparatus 100B shown in FIG. 1 has the same structure as that of the first display apparatus 100A but has a horizontally reversed structure, and no detailed description of the second display apparatus 1008 will therefore be made. In the description, among the components of the first display apparatus 100A, the image formation section 10 and the light guide section 20, which are directly involved in image formation, are called an image formation unit IP.

In the state shown in FIGS. 2A and 2B, the direction oriented exactly frontward from the wearer is the direction along a second optical axis AX2, which is the light exiting-side optical axis of the optical system that forms the virtual image display apparatus 100, and X, Y, and Z directions are defined as follows: a −Z direction is the direction in which the second optical axis AX2 extends from the virtual image display apparatus 100 toward the wearer; ±Y directions are upward and downward directions along which the wearer's eyes are not aligned with each other; and ±X directions are rightward and leftward directions along which the wearer's eyes are aligned with each other.

The image formation section 10 includes an image display portion 11 and a projection system 12. The image display portion 11 includes an illuminator 31, which radiates two-dimensional illumination light SL, a liquid crystal display device 32, which is a transmissive spatial light modulator, that is, a light modulating device, and a drive controller 34, which controls the operation of the illuminator 31 and the liquid crystal display device 32.

The illuminator 31 includes a light source 31a, which emits light containing red, green, and blue three color light components, and a backlight guide 31b, which diffuses the light from the light source 31a to form a light flux having a rectangular cross-sectional shape. The liquid crystal display device 32 spatially modulates the illumination light SL from the illuminator 31 to form image light to be displayed, such as motion images. The drive controller 34 includes a light source drive circuit 34a and a liquid crystal drive circuit 34b. The light source drive circuit 34a supplies the light source 31a in the illuminator 31 with electric power to allow the light source 31a to emit illumination light SL having stable luminance. The light source drive circuit 34a can also adjust the amount of supplied electric power to adjust the amount of illumination light SL from the illuminator 31 and hence to adjust the amount of image light GL. For example, the light control can be so performed that the rectangular area of the light having exited from the backlight guide 31b is divided and the amount of light is changed on a divided area basis. The liquid crystal drive circuit 34b outputs an image signal or a drive signal to the liquid crystal display device 32 to allow it to form color image light based on which motion images or still images are produced in the form of a transmittance pattern.

The projection system 12 is a collimator lens that combines the image light having exited from each point on the liquid crystal display device 32 into a parallelized light flux.

As described above, the image display portion 11 and the projection system 12, which form the image formation section 10, function as a key portion of the virtual image formation unit IP, which forms image light based on which a virtual image is formed.

The light guide section 20 is formed of a light guide member 21 and a light transmissive member 23 bonded to each other and forms a flat-plate-shaped optical member extending as a whole in parallel to the XY plane. The light guide section 20, which is formed of the light guide member 21 and the light transmissive member 23, functions as a see-through-type member that not only transmits environment light but also forms a virtual image from image light.

In the light guide section 20, the light guide member 21 is a trapezoidal-prism-shaped member in a plan view and has the following side surfaces: a first reflection surface 21a, a second reflection surface 21b, a third reflection surface 21c, and a fourth reflection surface 21d. The first reflection surface 21a and the second reflection surface 21b extend along the XY plane. The third reflection surface 21c is inclined to the XY plane by an acute angle α, which is smaller than or equal to 45°, and the fourth reflection surface 21d is inclined to the XY plane by an acute angle β, which is, for example, smaller than or equal to 45°. A first optical axis AX1, which is an optical axis passing through the third reflection surface 21c, that is, the light incident-side optical axis of the optical system, and the second optical axis AX2, which is an optical axis passing through the fourth reflection surface 21d, that is, the light exiting-side optical axis of the optical system, are disposed in parallel to each other.

The light guide member 21 is made of a resin material having high light transmittance in the visible region. The light guide member 21 is formed of a body portion 20a, which is a block-shaped member integrally molded in an injection molding process. The light guide member 21, which is formed of the body portion 20a that serves as a base and is an integrally formed part as described above, can be functionally divided into a light incident portion B1, a light guide portion B2, and a light exiting portion B3.

The light incident portion B1 is a triangular-prism-shaped portion and has a light incident surface IS, which is part of the first reflection surface 21a, and the third reflection surface 21c, which faces the light incident surface IS. The light incident surface IS is a flat surface that is disposed on the rear side or the wearer side and introduces image light GL from the image formation section 10, faces the projection system 12, and extends in the direction perpendicular to the first optical axis AX1 of the projection system 12. The third reflection surface 21c has a rectangular contour and has a mirror layer 25 formed on the entire rectangular area, and the mirror layer 25 is a total reflection mirror that reflects the image light GL having passed through the light incident surface IS and guides the reflected light into the light guide portion B2. The mirror layer 25 is formed in a film formation process of depositing aluminum or any other suitable material on an inclined surface RS of the body portion 20a of the light guide member 21. The third reflection surface 21c is inclined to the first optical axis AX1 of the projection system 12 or the XY plane by the acute angle α ranging, for example, from 25° to 27° and deflects the image light GL incident through the light incident surface IS and traveling as a whole in the direction in such a way that the deflected image light GL travels as a whole in the −X direction but inclined toward the −Z direction, whereby the image light GL is reliably introduced into the light guide portion B2.

The light guide portion B2 has the following two flat surfaces facing each other and extending in parallel to the XY plane: the first reflection surface 21a and the second reflection surface 21b, each of which totally reflects the image light deflected by the light incident portion B1. It is assumed in the description that the first reflection surface 21a is located on the rear side or the wearer side close to the image formation section 10, and the second reflection surface 21b is located on the front side or the environment side far away from the image formation section 10. In this case, the first reflection surface 21a is a surface portion common to the light incident surface IS, which has been described above, and a light exiting surface OS, which will be described later. Each of the first reflection surface 21a and the second reflection surface 21b is a surface that totally reflects light based on a refractive index difference.

The image light GL reflected off the third reflection surface 21c of the light incident portion 81 is first incident on and totally reflected off the first reflection surface 21a. The image light GL is then incident on and totally reflected off the second reflection surface 21b. The image light, which repeatedly undergoes the action described above, is guided as a whole in a primary light guiding direction toward the far side of the light guide section 20, that is, toward the −X side where the light exiting portion B3 is disposed. Neither the first reflection surface 21a nor the second reflection surface 21b has a reflection coating provided thereon, and environment light or external light incident from the environment on the second reflection surface 21b therefore passes through the light guide portion B2 at high transmittance. That is, the light guide portion 82 is a see-through-type portion that allows see-through observation of an environment light image.

The light exiting portion 83 is a triangular-prism-shaped portion and has a light exiting surface OS, which is part of the first reflection surface 21a, and the fourth reflection surface 21d, which faces the light exiting surface OS. The light exiting surface OS is a rear-side flat surface through which the image light GL exits toward a wearer's eye EY, is part of the first reflection surface 21a as the light incident surface IS is, and extends in the direction perpendicular to the second optical axis AX2. The fourth reflection surface 21d is a rectangular flat surface and has a half-silvered mirror layer 28 in a rectangular sub-area defined in a central portion of the fourth reflection surface 21d. The half-silvered mirror layer 28 not only reflects the image light GL incident thereon via the first reflection surface 21a and the second reflection surface 21b so that the image light GL exits out of the light exiting portion 53 but also transmits environment light OL. The half-silvered mirror layer 28 is a semitransparent reflection film that partially transmits light. The half-silvered mirror layer 28 is formed in a film formation process of forming a metal reflection film or a dielectric multilayer film made, for example, of silver on an inclined surface RR, which forms the fourth reflection surface 21d of the light guide member 21. The reflectance of the half-silvered mirror layer 28 that reflects the image light GL is set at a value greater than or equal to 10% but smaller than or equal to 50% provided that the image light GL is incident at an angle of incidence within an expected range and in consideration of facilitating see-through observation of the environment light OL.

The fourth reflection surface 21d, which is inclined to the second optical axis AX2 perpendicular to the first reflection surface 21a or the XY plane, for example, by the acute angle α ranging from 25° to 27°, partially reflects the image light GL incident thereon via the first reflection surface 21a and the second reflection surface 21b of the light guide portion B2 and deflects the reflected light as a whole in the −Z direction. The image light GL thus passes through the light exiting surface OS.

The light transmissive member 23 is formed of a body portion 23s having the same refractive index as that of the body portion 20a of the light guide member 21 and has a first surface 23a, a second surface 23b, and a third surface 23c. The first surface 23a and the second surface 23b extend along the XY plane as the first reflection surface 21a and the second reflection surface 21b do. The third surface 23c is so disposed that it is inclined to the XY plane and faces the fourth reflection surface 21d of the light guide member 21 in parallel thereto. That is, the light transmissive member 23 is a wedge-shaped member sandwiched between the second surface 23b and the third surface 23c. The light transmissive member 23 is made of a resin material having high light transmittance in the visible region, as the light guide member 21 is. The body portion 23s of the light transmissive member 23 is a block-shaped member integrally molded in an injection molding process.

In the light transmissive member 23, the first surface 23a is disposed in an extension flat plane of the first reflection surface 21a of the light guide member 21 and located on the rear side close to the wearer's eye EY, and the second surface 23b is disposed in an extension flat plane of the second reflection surface 21b of the light guide member 21 and located on the front side far away from the wearer's eye EY. The third surface 23c is a rectangular light transmissive surface bonded to the fourth reflection surface 21d of the light guide member 21 with an adhesive. The angle between the first surface 23a and the third surface 23c described above is equal to an angle ∈ between the second reflection surface 21b and the fourth reflection surface 21d of the light guide member 21, and the angle between the second surface 23b and the third surface 23c is equal to the angle β between the first reflection surface 21a and the fourth reflection surface 21d of the light guide member 21.

The light transmissive member 23 and the light guide member 21, which are bonded to each other, form a see-through portion B4 formed of the bonded portion and a portion in the vicinity thereof. That is, neither the first surface 23a nor the second surface 23b has a reflection coating, such as a mirror layer, provided thereon, and the environment light OL therefore passes through the first surface 23a and the second surface 23b at high transmittance, as the environment light OL passes through the light guide portion 82 of the light guide member 21. The third surface 23c can also transmit the environment light OL at high transmittance, but the fourth reflection surface 21d of the light guide member 21 has the half-silvered mirror layer 28, and the environment light OL passing through a central area of the third surface 23c is therefore attenuated. That is, the wearer views the attenuated image light GL and environment light OL superimposed on each other. The light guide section 20, which also works as an irradiated portion that is irradiated with image light to form a virtual image, functions as a key portion of the virtual image formation unit IP and superimposes an environment light image and a virtual image on each other for see-through observation.

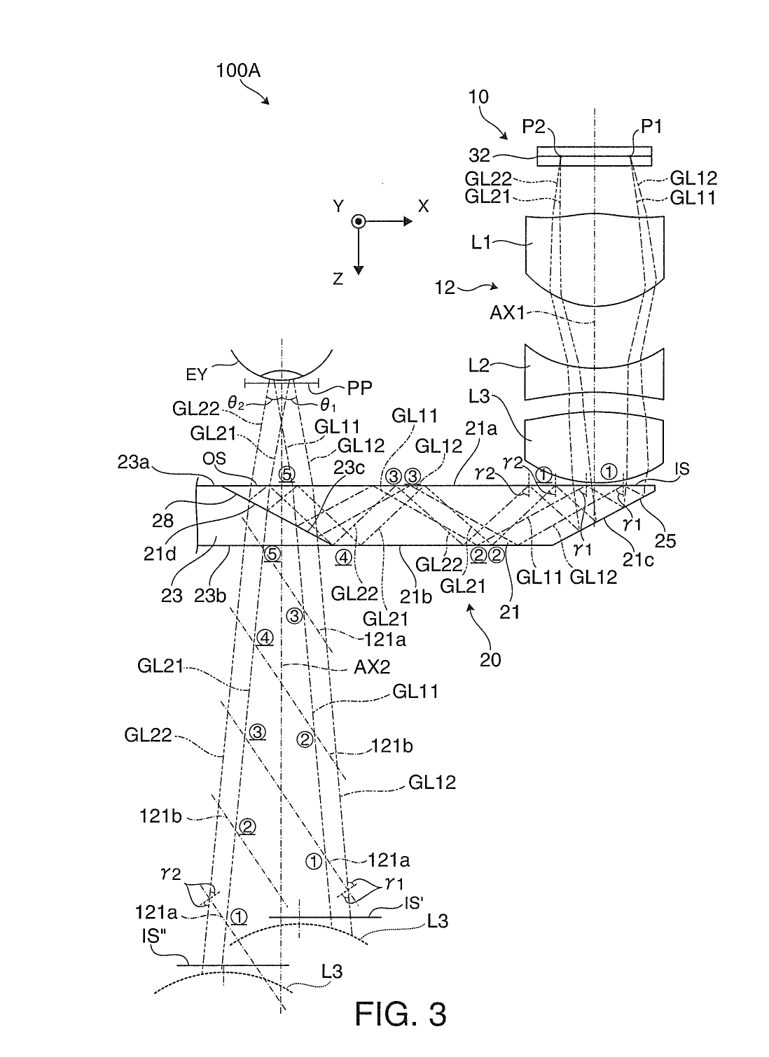

An exemplary specific optical path of the image light in the first display apparatus 100A will be described below with reference to FIG. 3. FIG. 3 shows only an optical system involved in determination of the optical path of the image light. Further, the projection system 12 is assumed to include three lenses L1, L2, and L3.

As shown in FIG. 3, image light GL11 and image light GL12 from a first display point P1 in a right portion of the liquid crystal display device 32 are totally reflected off the first reflection surface 21a and the second reflection surface 21b always at a first angle of reflection γ1 three times in total and incident on the fourth reflection surface 21d. The image light GL11 and the image light GL12 are reflected off the fourth reflection surface 21d at the same angle of reflection as the angle of reflection at which they are reflected off the third reflection surface 21c and exits through the light exiting surface OS as parallelized light fluxes inclined by an angle θ₁ to the second optical axis AX2, which is perpendicular to the light exiting surface OS.

Image light GL21 and image light GL22 from a second display point P2 in a left portion of the liquid crystal display device 32 are totally reflected off the first reflection surface 21a and the second reflection surface 21b always at a second angle of reflection γ2 five times in total and incident on the fourth reflection surface 21d. The image light GL21 and the image light GL22 are reflected off the fourth reflection surface 21d at the same angle of reflection as the angle of reflection at which they are reflected off the third reflection surface 21c and exits through the light exiting surface OS as parallelized light fluxes inclined by an angle θ₂ to the second optical axis AX2, which is perpendicular to the light exiting surface OS.

Further, the development diagram of the light guide member 21 in FIG. 3 shows two light incident equivalent planes IS′ and IS″ corresponding to the light incident surface IS but located in different positions and shows that the wearer views the lens L3 of the projection system 12 present in the vicinity of the light incident equivalent plane IS′ and the lens L3 present in the vicinity of the light incident equivalent plane IS″ overlapping with each other.

Since an image projected by a head-mounted display, such as the virtual image display apparatus 100, moves as the wearer moves, the projected image follows the wearer and does not go out of sight of the wearer who moves, unlike an environment light image. The situation in which a projected image always follows motion of the wearer may cause a very unpleasant sensation of the wearer, and the wearer may even develop a motion-sickness-like symptom in some cases. On the other hand, in the image formation described above, the wearer determines the position of the image, that is, the position of the image area based on the angle of incidence of the image light GL incident on the eye EY. Adjusting the angle of the image light GL therefore allows the wearer to recognize that the position of the image area is changed. In the present embodiment, the virtual image display apparatus 100, which includes a mechanism that adjusts the position of the image area in response to motion of the wearer, that is, a change in attitude of the wearer in such a way that the image area is shifted in the direction opposite the direction in which the wearer changes the attitude, reduces the amount of unpleasant sensation described above.

### C. Image Area Position Adjustment

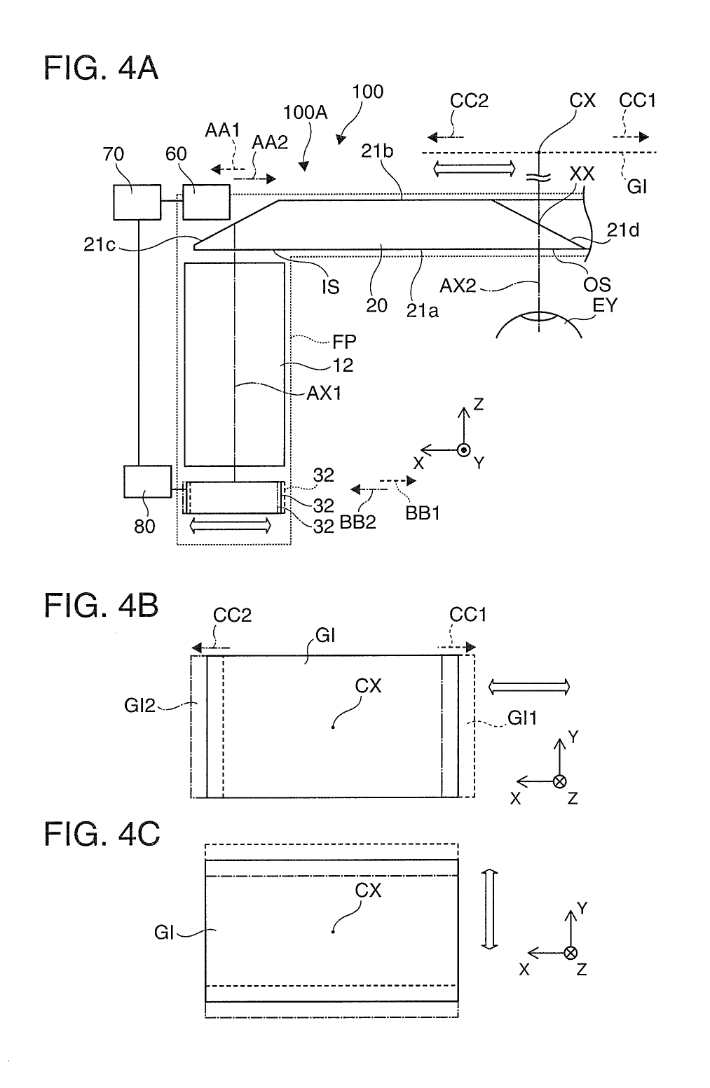

A description will be made of operation of the image area position adjustment according to a change in attitude of the wearer made by an attitude information detection unit 60, a device position drive unit 80, and other units in the virtual image display apparatus 100 with reference to FIG. 4A and other figures. In the present embodiment, the position of a displayed image area can be adjusted by using the device position drive unit 80 and other units to translate the liquid crystal display device 32 in a plane parallel to the light incident surface IS of the light guide section 20, that is, in a plane parallel to the XY plane. Among conceivable examples of the change in attitude of the wearer, such as a change resulting from rotary motion and a change resulting from translational motion, it is assumed in the description that the position of an image area is adjusted in accordance with a change in the attitude resulting from rotary (pivotal) motion of the neck, which is considered as a primary example of the change in the attitude of the wearer who wears the apparatus.

The virtual image display apparatus 100 includes an attitude information detection unit 60, which detects information on a change in the attitude of the wearer, that is, motion of the neck of the wearer, an arithmetic processing unit 70, which calculates the amount of correction and other necessary values based on the detection result from the attitude information detection unit 60, and a device position drive unit 80, which moves the liquid crystal display device based on the calculation result from the arithmetic processing unit 70.

The attitude information detection unit 60, which is a device formed, for example, of an angular velocity sensor, such as a gyro sensor, or an acceleration sensor, is attached to a fixing member FP, which positions and fixes the light guide section 20 and a variety of other components that move with the wearer, and the thus configured attitude information detection unit 60 can detect information on a change in the attitude produced when the wearer moves the neck. It is assumed in the description that a horizontally swinging action of the neck is detected as motion in the X direction, and a vertically swinging action of the neck is detected as motion in the Y direction.

The arithmetic processing unit 70 is formed of an arithmetic circuit and other components and calculates various pieces of information on a change in the attitude of the wearer based on a detection result from the attitude information detection unit 60, such as the amount of change in position, the amount of change in angle, and the speed of the change. In the description, in particular, among the parameters related to a change in the attitude, the amount of change in angle resulting from motion of the neck is read. Further, the arithmetic processing unit 70 calculates the amount of movement and other necessary parameters of the liquid crystal display device 32 according to a change in the attitude and transmits various types of control signal, such as a drive signal, based on the calculation result to the device position drive unit 80. The control signals are so formed that the liquid crystal display device 32 is moved in the direction opposite the direction in which the wearer moves. For example, when rotary motion produced when the wearer moves the neck is detected, the arithmetic processing unit 70 can calculate the amount of movement, the speed of the movement, and other values of the position of the image area in terms of pixel in correspondence with the detected angle of rotation, angular velocity, and other values, and the device position drive unit 80 can perform moving operation in accordance with the amount of movement.

The device position drive unit 80 is formed, for example, of a linear motor or a piezoelectric motor, and moves the liquid crystal display device 32 in the X and Y directions by the amount of movement and at a moving speed based on a drive signal from the arithmetic processing unit 70.

As described above, the arithmetic processing unit 70 and the device position drive unit 80 form a movement control mechanism that functions as an image area position adjustment mechanism that adjusts the position of the image area based on the attitude information detection unit 60.

Specific operation of the image area position adjustment will be described below with reference to FIGS. 4A to 4C. It is assumed in FIG. 4A that the wearer recognizes an image area GI, which is indicated by the broken line and on which an image formed of a virtual image is displayed, in an imaginary plane parallel to the XY plane. The position of the image area GI in a normal location before the position adjustment shown in FIG. 4A is so defined that the center CX of the image area GI is on an extension of the second optical axis AX2, which passes through the center XX of the fourth reflection surface 21d. In other words, the image area GI is formed exactly in front of the wearer (in XY plane), and the position of the image area GI through which the second optical axis AX2, which is an axis passing through the center of the wearers eye EY, passes in the exactly forward direction (Z direction) is the center CX of the position of the image area GI (image area position). Under this definition, the position of the image area GI, that is, the image area position is further defined with respect to the center CX. The position of the image area GI (image area position) is translated in the X direction indicated by the broken line or in the Y direction indicated by the dashed line from the normal position indicated by the solid line, as shown in FIGS. 4B and 4C. As a specific method for moving the image area GI, the image area position of the image area GI can be adjusted by using the device position drive unit 80 to physically move the liquid crystal display device 32 as described above. In the following sections, only a movement (shift) in the right-left direction, that is, the X direction shown in FIG. 4B will be described, and a movement (shift) in the up-down direction, that is, the Y direction shown in FIG. 4C will not be described in detail because the two types of movement are made in the same manner.

As described above, when the attitude information detection unit 60 detects that the wearer changes the attitude rightward or leftward, that is, the wearer moves the neck horizontally, the arithmetic processing unit 70 determines a drive signal by calculation and the device position drive unit 80 moves the liquid crystal display device 32 rightward or leftward based on the drive signal.

In the operation described above, for example, when the attitude information detection unit 60 detects motion in the +X direction indicated by the arrow AA1, the arithmetic processing unit 70 and the device position drive unit 80 make an adjustment in which the image area position is moved in the −X direction indicated by the arrow B131. As a result, the image area GI is shifted in the direction indicated by the arrow CC1 and becomes an image area GI1, as shown in FIGS. 4A and 4B.

On the other hand, when the attitude information detection unit 60 detects motion in the −X direction indicated by the arrow AA2, the arithmetic processing unit 70 makes an adjustment through the device position drive unit 80 in such a way that the image area position is moved in the +X direction indicated by the arrow BB2. As a result, the image area GI is shifted in the direction indicated by the arrow CC2 and becomes an image area GI2, as shown in FIGS. 4A and 4B.

Similarly, when a change in either the upward or downward direction, that is, vertical motion of the wearer's neck is detected, the arithmetic processing unit 70 and the device position drive unit 80 shift the position of the image area GI upward or downward, as shown in FIG. 4C.

As described above, the arithmetic processing unit 70 and the device position drive unit 80, when they make the position adjustment as the image area position adjustment mechanism, perform counter correction operation control in which the position of the image area formed in the light guide section 20 is shifted in the direction opposite the direction in which the wearer changes the attitude based on a detection result from the attitude information detection unit 60. The control described above allows the wearer who changes the attitude to recognize that an image in the form of a virtual image does not follow the motion of the wearer as if the image remained still as an environment light image does. As a result, a situation in which the wearer has an unpleasant sensation resulting from an image in the form of a virtual image and even a symptom similar to motion sickness will not occur.

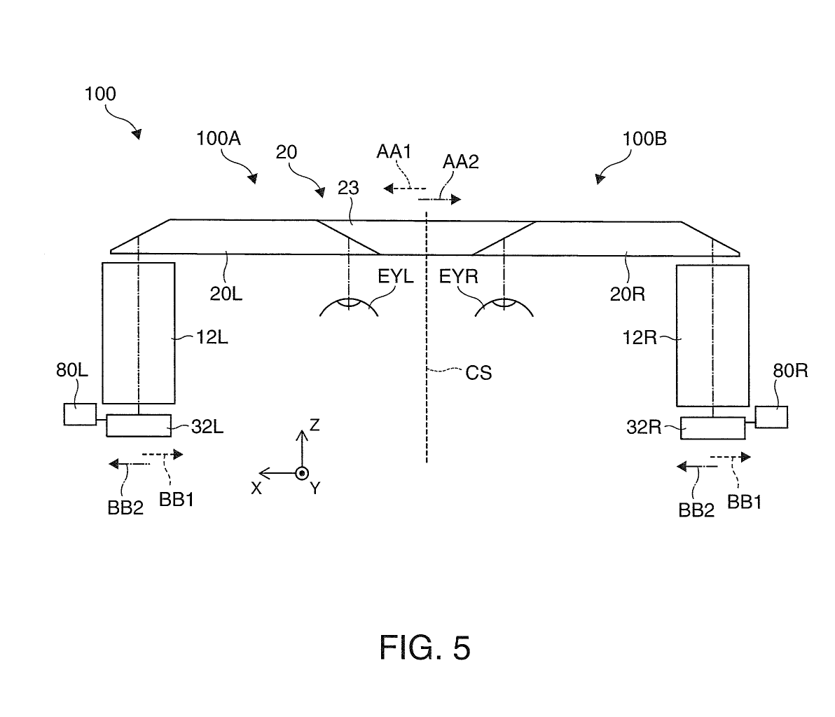

A description will next be made of the relationship between left image correction operation performed by the first display apparatus 100A and right image correction operation performed by the second display apparatus 100B with reference to FIG. 5. In the virtual image display apparatus 100, the first display apparatus 100A includes a projection system 12L, a light guide member 21L, a liquid crystal display device 32L, and a device position drive unit 80L as the variety of devices and optical systems or the image area position adjustment mechanism described above. Similarly, the second display apparatus 100B includes a projection system 12R, a light guide member 21R, a liquid crystal display device 32R, and a device position drive unit 80R. It is noted that the first display apparatus 100A and the second display apparatus 100B are a pair of right and left display apparatus having the same structure, and one of them can be reversed with respect to a central plane CS into the other or they are arranged in what is called a mirror-image symmetrical manner, as described above. Further, the light guide members 21L and 21R are integrated with each other with the light transmissive member 23 located at the center of the entire apparatus to form the single light guide section 20.

The image area position adjustment operation, that is, the correction operation based on counter correction will be specifically described below. The device position drive unit 80L in the first display apparatus 100A and the device position drive unit 80R in the second display apparatus 100E move the liquid crystal display device 32L and the liquid crystal display device 32R respectively relative to the light guide section 20 in accordance with control signals from the arithmetic processing unit (not shown) based on a detection result from the attitude information detection unit (not shown). In this process, when it is determined that the attitude has been changed, for example, in the direction indicated by the arrow AA1 (+X direction), the device position drive unit 80L moves the liquid crystal display device 32L in the direction indicated by the arrow BB1 (−X direction). Further, the device position drive unit 80R also moves the liquid crystal display device 32R in the direction indicated by the arrow BB1 (−X direction). Conversely, when it is determined that the attitude has been changed in the direction indicated by the arrow AA2 (−X direction), the device position drive units 80L and 80R move the liquid crystal display devices 32L and 32R respectively in the direction indicated by the arrow BB2 (+X direction).

In the above discussion, the display apparatus 100A and 100B perform the moving operation in the same direction, either of the ±X directions, from the viewpoint of image area position movement. However, since the first display apparatus 100A and the second display apparatus 100B have the mirror-image symmetrical structures, the operations described above are horizontally reversed with respect to each other from the viewpoint of the mechanisms of the display apparatus 100A and 100B. For example, a movement of the liquid crystal display device 32L in the +X direction (arrow BB2) in the first display apparatus 100A is a movement away from the wearer's eye EYL, whereas a movement of the liquid crystal display device 32R in the +X direction (arrow BB2) in the second display apparatus 100B is a movement toward the wearer's eye EYR.

As described above, in the present embodiment, the attitude information detection unit 60 detects information on the attitude of the wearer, and the arithmetic processing unit 70 and the device position drive unit 80, which form the image area position adjustment mechanism, translate the liquid crystal display device 32, which is a light modulating device, relative to the light guide section 20 in a plane parallel to the light incident surface IS of the light guide section 20 based on the detection result from the attitude information detection unit 60, whereby the image area position can be so changed that an image moves in the direction opposite the direction in which the wearer moves. The position control described above allows the wearer who moves to recognize that the image does not follow the motion of the wearer as if the image remained still, whereby even when the wearer moves, the amount of unpleasant sensation felt by the wearer resulting from the motion can be reduced.

Further, it is assumed in the above description that a change in the attitude of the wearer resulting from rotary (pivotal) motion of the neck, which is considered as a primary example of a change in the attitude, is detected, and that the image area position is adjusted in accordance with the change. Another conceivable example of a change in the attitude of the wearer is a change resulting from translational motion. For example, when the wearer moves not only the neck but also the entire body or the entire upper body, the latter produces translational motion and the wearer may have an unpleasant sensation resulting from the translational motion in some cases. In such a case as well, for example, the attitude information detection unit 60 detects a change resulting from the translational motion as information on the attitude, and the arithmetic processing unit 70 calculates the amount of correction as appropriate, whereby the image area position can be adjusted.

### Second Embodiment

A virtual image display apparatus according to a second embodiment will be described below. The virtual image display apparatus according to the present embodiment is a variation of the virtual image display apparatus 100 according to the first embodiment and has the same exterior structure as that of the virtual image display apparatus 100 except the image area position adjustment mechanism. No illustration or description of the virtual image display apparatus according to the present embodiment as a whole will therefore be made.

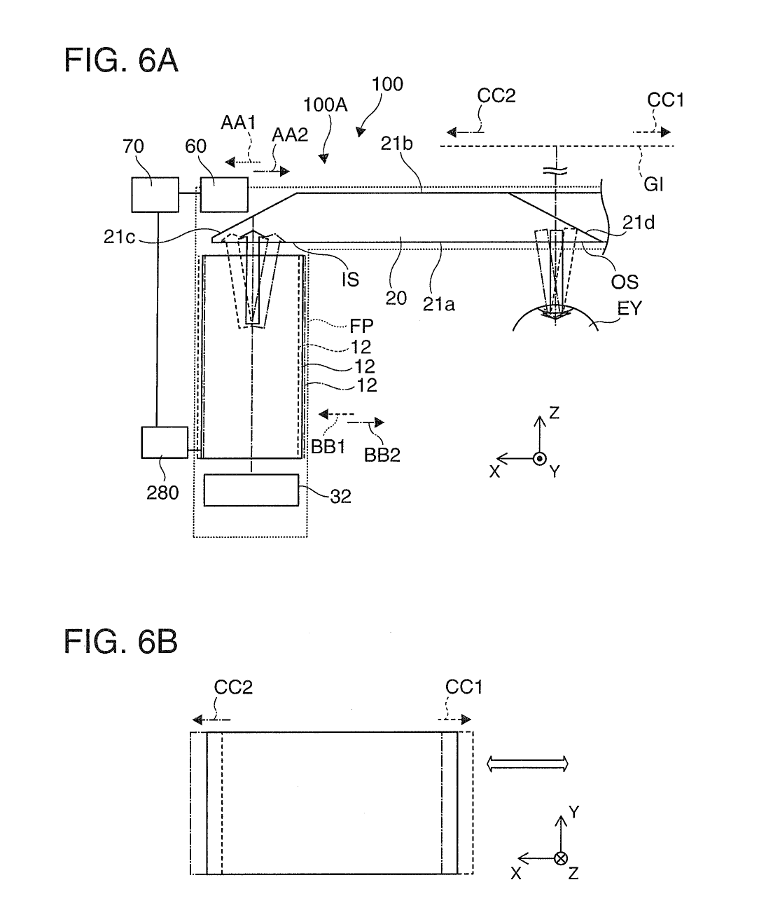

FIGS. 6A and 6B correspond to FIGS. 4A and 4B in the first embodiment and describe an optical system position drive unit 280, which forms an image area position adjustment mechanism in the virtual image display apparatus according to the present embodiment.

The optical system position drive unit 280 moves the projection system 12 in the X and Y directions based on a drive signal from the arithmetic processing unit 70.

As described above, the arithmetic processing unit 70 and the optical system position drive unit 280 form a movement control mechanism that functions as an image area position adjustment mechanism that adjusts the image area position based on the attitude information detection unit 60.

A description will be made of specific operation of the image area position adjustment made by the optical system position drive unit 280 and other components. When the attitude information detection unit 60 detects that the wearer changes the attitude rightward or leftward, the optical system position drive unit 280 moves the projection system 12 rightward or leftward in accordance with a drive signal determined by calculation by the arithmetic processing unit 70. In the operation described above, when the attitude information detection unit 60 detects motion in the +X direction indicated by the arrow AA1, for example, the arithmetic processing unit 70 and the optical system position drive unit 280 make an adjustment in such a way that the projection system 12 is moved in the +X direction indicated by the arrow BB1. As a result, an image area GI moves in the direction indicated by the arrow CC1 and becomes an image area GI1, as shown in FIG. 6B. That is, the optical system position drive unit 280 in the present embodiment moves the projection system in the direction opposite the direction in which the device position drive unit 80 moves the liquid crystal display device 32 in the first embodiment.

For example, when the projection system 12 is moved in the direction indicated by the arrow BB1 (+X direction), among image light components that exit out of the projection system 12, a component SS located in the vicinity of the center of the entire image light and containing a principal ray oriented in a direction substantially perpendicular to the light incident surface IS becomes a component SS1 containing a principal ray inclined slightly outward as indicated by the broken line in FIG. 6A. As a result, the component SS1, when it exits out of the light guide section 20, becomes inclined slightly inward instead of being perpendicular to the light exiting surface OS. The wearer, who determines the position of an image based on the angle at which the light exits, recognizes that the component SS1 inclined slightly inward instead of being perpendicular to the light exiting surface OS, that is, angled primarily in the −Z direction but slightly shifted toward the +X direction forms an image shifted toward the −X side. Further, when the projection system 12 is moved in the direction indicated by the arrow BB1 (+X direction), components other than those in the vicinity of the center are also slightly inclined outward when incident on the light incident surface IS and slightly inclined inward when exiting through the light exiting surface OS. In the case described above, the wearer therefore recognizes that the entire image moves in the direction indicated by the arrow CC1 as shown in FIG. 68.

Conversely, when the projection system 12 is moved in the direction indicated by the arrow BB2 (−X direction), among the image light components that exit out of the projection system 12, the component SS located in the vicinity of the center of the entire image light and containing the principal ray oriented in the direction substantially perpendicular to the light incident surface IS becomes a component SS2 containing a principal ray inclined slightly inward as indicated by the dashed line in FIG. 6A. As a result, the component SS2, when it exits out of the light guide section 20, becomes inclined slightly outward instead of being perpendicular to the light exiting surface OS. The components other than those in the vicinity of the center also behave in the same manner. As a result, the wearer recognizes that the entire image moves in the direction indicated by the arrow CC2 as shown in FIG. 6B.

Although no detailed description or illustration will be made, an adjustment is made in the same manner for motion in the up-down direction, that is, in the Y direction. In this case as well, the projection system 12 is moved in the direction opposite the direction in which the liquid crystal display device 32 is moved in the first embodiment.

In the present embodiment, the arithmetic processing unit 70 and the optical system position drive unit 280, which form the image area position adjustment mechanism, translate the projection system 12 relative to the light guide section 20 in a plane parallel to the light incident surface IS of the light guide section 20 based on a detection result from the attitude information detection unit 60, whereby the image area position can be so changed that an image moves in the direction opposite the direction in which the wearer moves.

### Third Embodiment

A virtual image display apparatus according to a third embodiment will be described below. The virtual image display apparatus according to the present embodiment is a variation of the virtual image display apparatus according to the first embodiment and other embodiments and is the same as the virtual image display apparatus according to the first embodiment and other embodiments except the image area position adjustment mechanism. No illustration or description of the virtual image display apparatus according to the present embodiment as a whole will therefore be made.

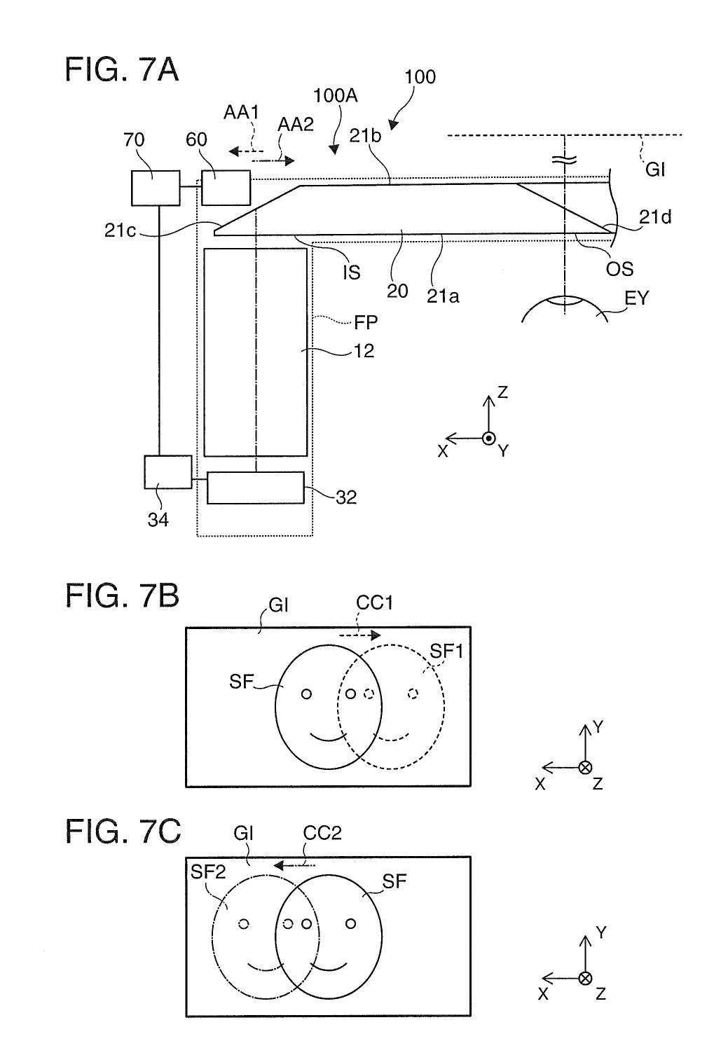

FIG. 7A corresponds to FIG. 4A in the first embodiment, and FIGS. 7B and 7C correspond to FIG. 4B. FIGS. 7A to 7C describe an image area position adjustment mechanism in the virtual image display apparatus according to the present embodiment.

In the virtual image display apparatus according to the present embodiment, a drive control unit 34, which controls the operation of the liquid crystal display device 32, is connected to the arithmetic processing unit 70. The drive control unit 34 controls modulation operation in the liquid crystal display device 32 based not only on a normal image signal but also on a control signal from the arithmetic processing unit 70. That is, the arithmetic processing unit 70 and the drive control unit 34 form a modulation control mechanism that functions as an image area position adjustment mechanism that adjusts the image area position based on the attitude information detection unit 60.

A description will be made of specific operation of the image area position adjustment made by the arithmetic processing unit 70 and the drive control unit 34. When the attitude information detection unit 60 detects that the wearer changes the attitude rightward or leftward, the drive control unit 34 shifts the position where an image to be displayed is displayed in accordance with a control signal determined by calculation by the arithmetic processing unit 70. For example, when the attitude information detection unit 60 detects motion in the +X direction indicated by the arrow AA1, the arithmetic processing unit 70 and the drive control unit 34 shift the entire image to form an image having moved in the −X direction indicated by the arrow CC1 in an image area GI, as shown in FIG. 7B. For example, in the image area GI, an image SF that occupies an area in the vicinity of the center of the image area GI is moved in the −X direction to form an image SF1. On the other hand, when the attitude information detection unit 60 detects motion in the −X direction indicated by the arrow AA2, the arithmetic processing unit 70 and the drive control unit 34 move the image SF in the +X direction to form an image SF2, as shown in FIG. 7C.

Although no detailed description or illustration will be made, the modulation operation controlled by the drive control unit 34 allows an adjustment to be made in the same manner for motion in the up-down direction, that is, the Y direction.

In the present embodiment, the arithmetic processing unit 70 and the drive control unit 34, which form the image area position adjustment mechanism, control the modulation operation based on a detection result from the attitude information detection unit 60, whereby the image area position can be so changed that an image moves in the direction opposite the direction in which the wearer moves. Compare now the present embodiment with the other embodiments described above. The position where an entire image is projected is changed to change the position of an image area for the image in the first and second embodiments, whereas the liquid crystal display device 32 adjusts the position of the image in advance to change the position of the image area for the image displayed as a virtual image as described above in the present embodiment.

### Fourth Embodiment

A virtual image display apparatus according to a fourth embodiment will be described below. The virtual image display apparatus according to the present embodiment is a variation of the virtual image display apparatus according to the first embodiment and other embodiments and is the same as the virtual image display apparatus according to the first embodiment and other embodiments except the image area position adjustment mechanism. No illustration or description of the virtual image display apparatus according to the present embodiment as a whole will therefore be made.

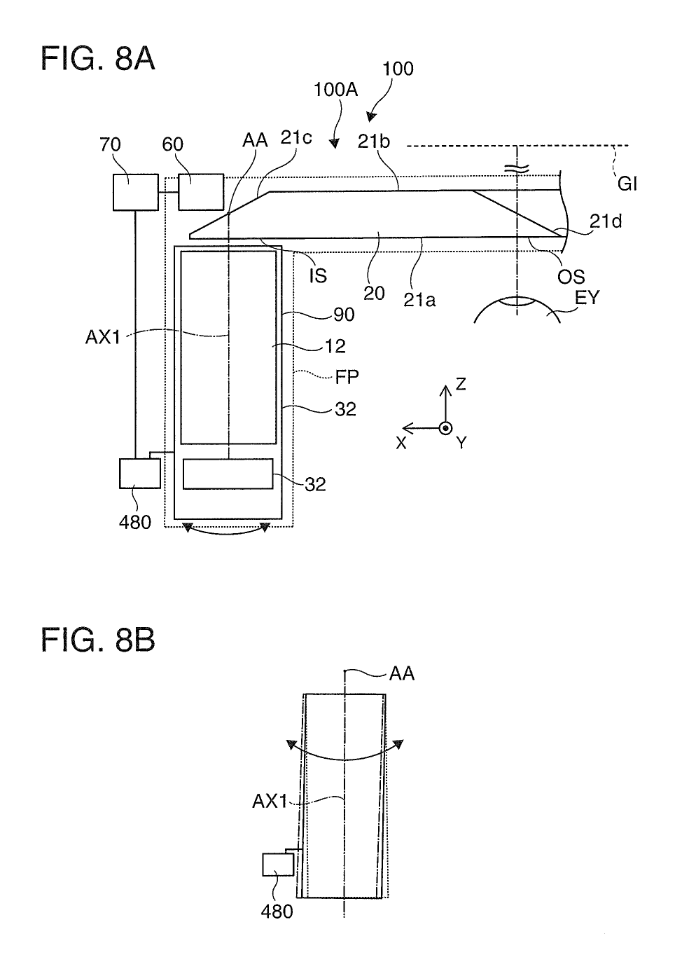

FIG. 8A corresponds to FIG. 4A in the first embodiment and describes a rotary drive unit 480 that forms an image area position adjustment mechanism in the virtual image display apparatus according to the present embodiment.

The rotary drive unit 480 moves the projection system 12 and other components based on a drive signal from the arithmetic processing unit 70.

As described above, the arithmetic processing unit 70 and the rotary drive unit 480 form a movement control mechanism that functions as an image area position adjustment mechanism that adjusts the image area position based on the attitude information detection unit 60.

The liquid crystal display device 32 and the projection system 12, which form image light, are attached to a frame 90 and positioned and fixed thereto as a unitary member. The rotary drive unit 480 drives and controls the liquid crystal display device 32 and the projection system 12 accommodated in the frame 90 as a whole in a rotatable manner, whereby the direction in which the image light having exited out of the projection system 12 is incident on the light guide section 20 can be adjusted. It is assumed in the description that the liquid crystal display device 32 and the projection system 12 are rotatable around an axis of rotation AA, which passes through the center of the first reflection surface 21a and is perpendicular to the XZ plane, which is a reference plane of the entire optical system. In other words, the rotary drive unit 480 can adjust the direction of the first optical axis AX1 by rotating the liquid crystal display device 32 and the projection system 12 in the XZ plane.

A description will be made of specific operation of the image area position adjustment made by the rotary drive unit 480 and other components. When the attitude information detection unit 60 detects that the wearer changes the attitude, the rotary drive unit 480 rotates the liquid crystal display device 32 and the projection system 12, which are accommodated in the frame 90, as a unitary member around the axis of rotation AA in accordance with a drive signal determined by calculation by the arithmetic processing unit 70, as shown in FIG. 8B, whereby the direction of a principal ray can be changed and the position of the displayed image area can be moved.

In the present embodiment, the arithmetic processing unit 70 and the rotary drive unit 480, which form the image area position adjustment mechanism, adjust the angle of incidence of the image light from the projection system 12 with respect to the light incident surface IS of the light guide section 20 based on a detection result from the attitude information detection unit 60, whereby the image area position can be so changed that an image moves in the direction opposite the direction in which the wearer moves.

In the above description, the center of rotation of the rotary movement made by the rotary drive unit 480 is the axis of rotation AA by way of example, but the axis of rotation can alternatively be set in any other suitable position.

Although no detailed description or illustration will be made, the rotary drive unit 480 also makes an adjustment for motion in the up-down direction, that is, the Y direction in the same manner by performing rotary operation around a different center of rotation.

### Fifth Embodiment

A virtual image display apparatus according to a fifth embodiment will be described below. The virtual image display apparatus according to the present embodiment is a variation of the virtual image display apparatus according to the fourth embodiment and is the same as the virtual image display apparatus according to the fourth embodiment except the component to be rotated by a rotary drive unit. No illustration or description of the virtual image display apparatus according to the present embodiment as a whole will therefore be made.

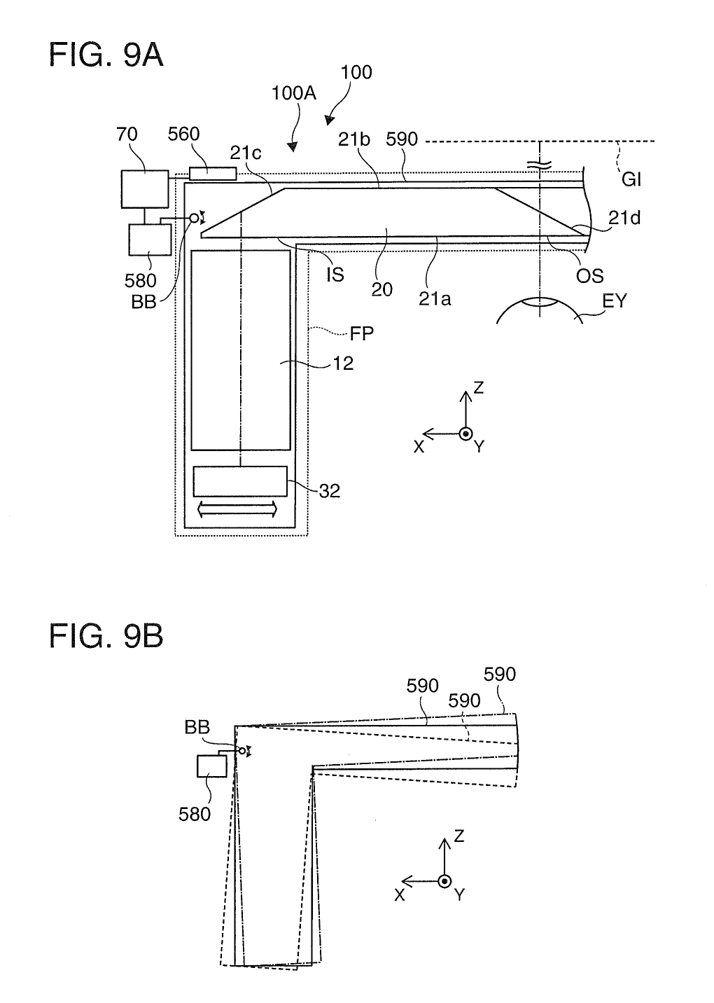

FIG. 9A corresponds to FIG. 8A in the fourth embodiment and describes a rotary drive unit 580 that forms an image area position adjustment mechanism in the virtual image display apparatus according to the present embodiment.

The rotary drive unit 580 moves the projection system 12 and other components based on a drive signal from the arithmetic processing unit 70.

As described above, the arithmetic processing unit 70 and the rotary drive unit 580 form a movement control mechanism that functions as an image area position adjustment mechanism that adjusts the image area position based on an attitude information detection unit 560.

A frame 590 is an attachment member that positions and fixes the liquid crystal display device 32, the projection system 12, the light guide section 20, and other components together, which form the entire optical system that forms an image. The rotary drive unit 580 drives and controls the frame 590 in a rotatable manner, whereby the direction of the light that exits toward the wearer's eye EY can be adjusted. It is assumed in the description that the entire optical system is rotatable as a unitary member around an axis of rotation BB, which is perpendicular to the XZ plane, which is a reference plane of the entire optical system. The attitude information detection unit 560 is so attached to the fixing member FP, which is a member separate from the frame 590, that the rotary action made by the rotary drive unit 580 does not affect the attitude information detection unit 560. In the illustration, the position of the axis of rotation BB is presented by way of example, and the axis of rotation BB can alternatively be set in any other suitable position.

A description will be made of specific operation of the image area position adjustment made by the rotary drive unit 580 and other components. When the attitude information detection unit 560 detects that the wearer changes the attitude, the rotary drive unit 580 rotates the liquid crystal display device 32, the projection system 12, and other components, which are accommodated in the frame 590, as a unitary member around the axis of rotation BB in accordance with a drive signal determined by calculation by the arithmetic processing unit 70, as shown in FIG. 9B, whereby the direction of the light that exits toward the wearer's eye can be changed and the position of the displayed image area can be moved.

In the present embodiment, the arithmetic processing unit 70 and the rotary drive unit 580, which form the image area position adjustment mechanism, adjust the angle of incidence of the image light from the projection system 12 with respect to the light incident surface IS of the light guide section 20 based on a detection result from the attitude information detection unit 560, whereby the image area position can be so changed that an image moves in the direction opposite the direction in which the wearer moves.

### Sixth Embodiment

A virtual image display apparatus according to a sixth embodiment will be described below. The virtual image display apparatus according to the present embodiment is a variation of the virtual image display apparatus according to the fourth embodiment and other embodiments and is the same as the virtual image display apparatus according to the fourth embodiment and other embodiments except the component to be rotated by a rotary drive unit. No illustration or description of the virtual image display apparatus according to the present embodiment as a whole will therefore be made.

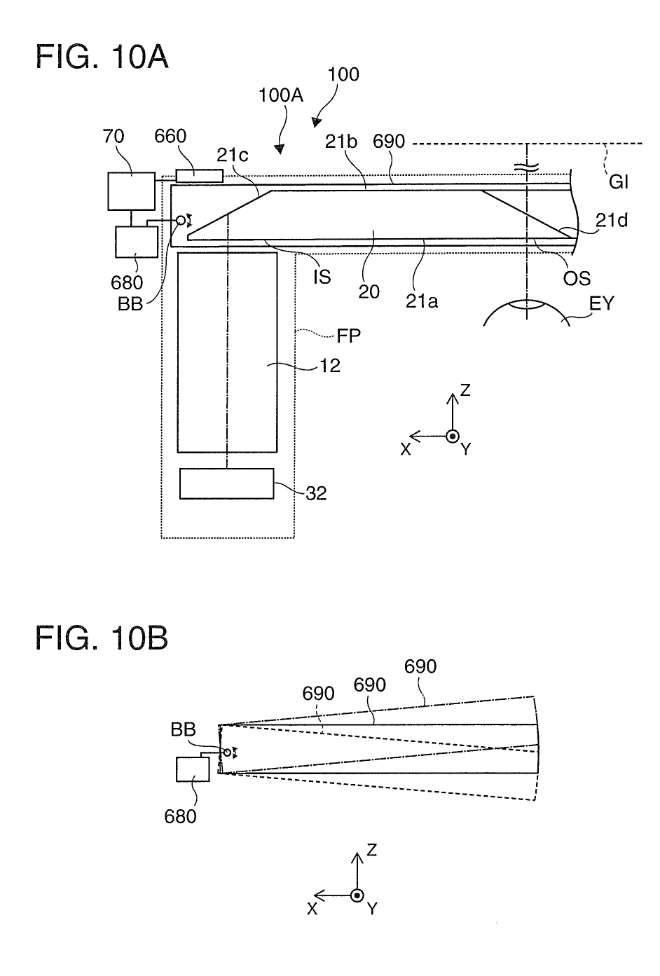

FIG. 10A corresponds to FIG. 8A in the fourth embodiment and describes a rotary drive unit 680 that forms an image area position adjustment mechanism in the virtual image display apparatus according to the present embodiment.

The rotary drive unit 680 moves the light guide section 20 and other components based on a drive signal from the arithmetic processing unit 70.

As described above, the arithmetic processing unit 70 and the rotary drive unit 680 form a movement control mechanism that functions as an image area position adjustment mechanism that adjusts the image area position based on an attitude information detection unit 660.

A frame 690 is an attachment member that positions and fixes the light guide section 20 and other members to be irradiated. The rotary drive unit 680 drives and controls the frame 690 in a rotatable manner, whereby the direction of the light that exits toward the wearer's eye EY can be adjusted. It is assumed in the description that the light guide section 20 and other members to be irradiated are rotatable as a unitary member around the axis of rotation BB, which is perpendicular to the XZ plane, which is a reference plane of the entire optical system. The attitude information detection unit 660 is so attached to the fixing member FP, which is a member separate from the frame 690, that the rotary action made by the rotary drive unit 680 does not affect the attitude information detection unit 660.

A description will be made of specific operation of the image area position adjustment made by the rotary drive unit 680 and other components. When the attitude information detection unit 660 detects that the wearer changes the attitude, the rotary drive unit 680 rotates the light guide section 20 and other components, which are accommodated in the frame 690, as a unitary member around the axis of rotation BB in accordance with a drive signal determined by calculation by the arithmetic processing unit 70, as shown in FIG. 10B, whereby the direction of the light that exit toward the wearer's eye can be changed and the position of the displayed image area can be moved. After reflected off the third reflection surface 21c, each light flux is reflected off the first reflection surface 21a and the second reflection surface 21b an odd number of times in total and then directed toward the fourth reflection surface 21d. In this case, an inclined light flux is incident on the light incident surface IS because the light guide section 20 is inclined, and the inclined light flux is then incident on the fourth reflection surface 21d with the angular state that includes the inclination maintained. Further, since the light guide section 20 and other components are rotated as a unitary member, the light exiting surface OS is also inclined to the viewer's eye EY. As a result, a light flux that exits through the light exiting surface OS and travels toward the eye EY is inclined by an angle twice the inclination of the light guide section 20 as compared with a light flux that exits and travels when the light guide section 20 has an inclination of 0 degrees.

In the present embodiment, the arithmetic processing unit 70 and the rotary drive unit 680, which form the image area position adjustment mechanism, adjust the attitude of the light guide section 20 and other members to be irradiated based on a detection result from the attitude information detection unit 660, whereby the image area position can be so changed that an image moves in the direction opposite the direction in which the wearer moves.

### Seventh Embodiment

A virtual image display apparatus according to a seventh embodiment will be described below. The virtual image display apparatus according to the present embodiment is a variation of the virtual image display apparatus according to the first embodiment and other embodiments and is the same as the virtual image display apparatus according to the first embodiment and other embodiments except that a rotary drive unit 780 that rotates the liquid crystal display device 32 in the XY plane is provided. No illustration or description of the virtual image display apparatus according to the present embodiment as a whole will therefore be made.

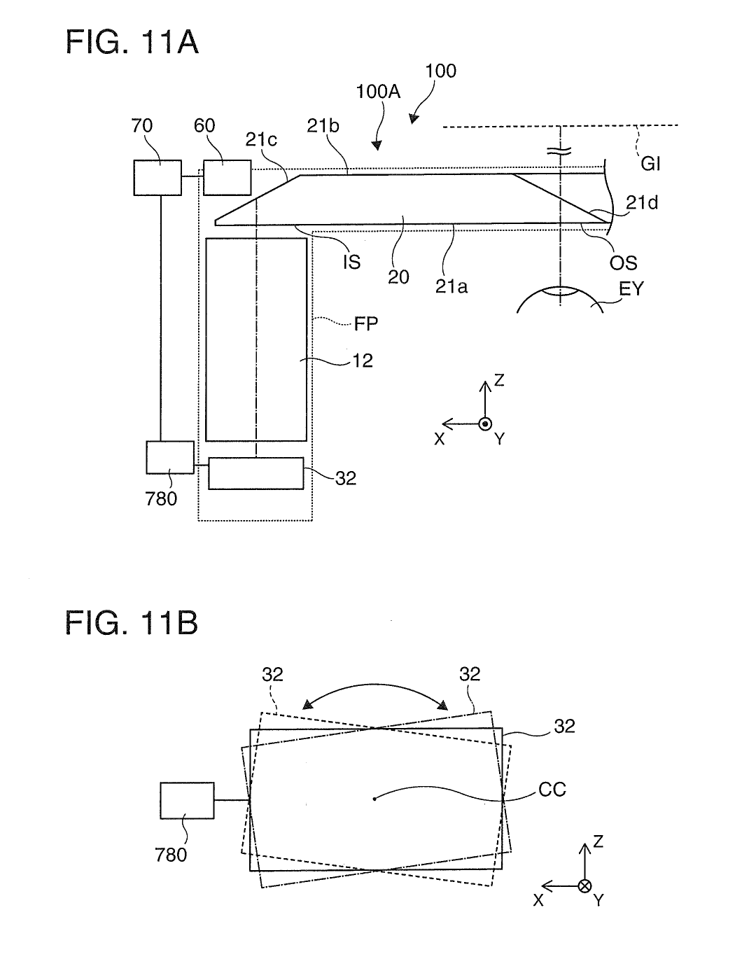

FIG. 11A corresponds to FIG. 4A in the first embodiment and describes the rotary drive unit 780 that forms an image area position adjustment mechanism in the virtual image display apparatus according to the present embodiment. FIG. 11B is a partial view of the virtual image display apparatus and shows correction operation made by the rotary drive unit 780, which rotates the liquid crystal display device 32.

When the arithmetic processing unit 70 shown in FIG. 11A acquires information on the rotation in the XY plane as the information on a change in the attitude from the attitude information detection unit 60, the arithmetic processing unit 70 transmits a control signal according to the information to the rotary drive unit 780. The rotary drive unit 780 rotates the liquid crystal display device 32 in the XY plane in accordance with the control signal from the arithmetic processing unit 70, as shown in FIG. 11B.

As described above, the arithmetic processing unit 70 and the rotary drive unit 780 form a movement control mechanism that functions as an image area position adjustment mechanism that adjusts the image area position based on the attitude information detection unit 60.

The rotary drive unit 780 according to the present embodiment can be provided in addition to the drive unit according to any of the other embodiments described above. For example, when the rotary drive unit 780 is provided in addition to the device position drive unit 80, the image area movement can be corrected in correspondence with not only upward, downward, rightward, and leftward swing action (swivel action) of the wearer's neck, that is, horizontal and vertical motion but also an action of inclining the neck rightward or leftward.

Further, image processing applied to rotary direction in the XY plane can also be performed as the modulation operation made by the drive control unit 34 according to the third embodiment.

### Eighth Embodiment

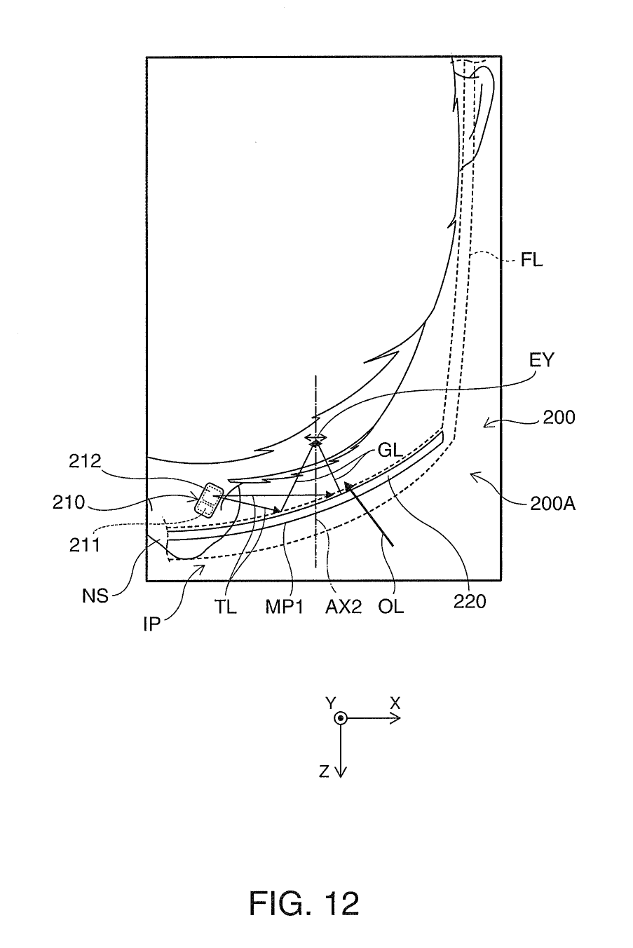

A virtual image display apparatus according to an eighth embodiment will be described below with reference to FIG. 12. In the following sections, an example of the structure of a first display apparatus 200A of a virtual image display apparatus 200 according to the present embodiment will be described in order to describe an example of the structure of the virtual image display apparatus 200. The first display apparatus 200A includes a light output section 210, which forms signal light and outputs the signal light as scanned light TL, and an irradiated member 220, which receives the scanned light TL from the light output section 210 to form image light GL. The light output section 210 is disposed in a position somewhere around the wearer's nose NS and includes a signal light formation portion 211 and a scan system 212. The irradiated member 220 is disposed in front of the light output section 210 (on +Z side) and covers a portion in front of the wearer's eye EY. The virtual image display apparatus 200 further includes an attitude information detection unit 860 and an arithmetic processing unit 870, and the arithmetic processing unit 870 is connected to the light output section 210.

The irradiated member 220 has a semitransparent semireflection film that is an irradiated film (semitransparent film) irradiated with the scanned light and a support member that supports and fixes the semitransparent semireflection film. That is, the irradiated member 220 is a half-silvered mirror, whereby the wearer's eye EY receives not only a virtual image but also light from the environment. The virtual image display apparatus 200 therefore has a see-through configuration that superimposes the two types of light and makes them observable. That is, the irradiated member 220 is a virtual image formation unit.

The irradiated member 220 is disposed in front of the wearer's eye EY and farther away from the light output section 210 with respect to the wearer (+Z side), as shown in FIG. 12. That is, the light output section 210 is disposed between the wearer's eye EY and the irradiated member 220.

The irradiated member 220, which has a size large enough to cover the wearer's eye EY from the front, receives the scanned light TL traveling via the scan system 212 of the light output section 210 along a line inclined toward the +Z direction and reflects the scanned light TL to form a virtual image to be recognized by the wearer. The irradiated member 220 is so shaped that it follows the exterior appearance of the virtual image display apparatus 200, that is, the shape of a frame FL.

The image formation operation will be described below. First, the signal light formation portion 211 of the light output section 210 is a signal light modulation portion that forms signal light and outputs the signal light. The outputted signal light is incident on the scan system 212, which is a scanner. The scan system 212 outputs the signal light in the form of scanned light toward the irradiated member 220. When the scanned signal light, which is the signal light in the form of scanned light, is incident on the irradiated member 220, a virtual image is formed from the image light GL and captured by the wearer's eye EY, and the image is thus recognized by the wearer.

In the virtual image display apparatus 200 having the configuration described in the present embodiment, providing an image area position adjustment mechanism as in the embodiments described above also allows the image area position to be so changed that an image moves in the direction opposite the direction in which the wearer moves as in the first embodiment and other embodiments. In the present embodiment, the arithmetic processing unit 870 and the light output section 210 connected to the arithmetic processing unit 870 function as the image area position adjustment mechanism. That is, the position of an image area to be formed can be adjusted by controlling the operation of the light output section 210 based on a result calculated by the arithmetic processing unit 870 in accordance with information on a change in the attitude from the attitude information detection unit 860.

In the above description, a diode laser light source or an LED light source is used as the light source. The light source may alternatively be any other light source, for example, an organic EL light source.

### Others

The invention has been described with reference to the above embodiments, but the invention is not limited thereto. The invention can be implemented in a variety of other aspects to the extent that they do not depart from the substance of the invention. For example, the following variations are conceivable.

The correction operation, that is, the adjustment operation described above may be continuously performed, or a choice mode may be so set that the wearer can choose whether or not the correction is made. Further, some motion of the wearer, such as slow motion, does not have an effect large enough to cause the wearer to have an unpleasant sensation. In view of the fact described above, for example, a threshold may be so set that a detection result detected by the attitude information detection unit 60 is used to determine whether or not the correction control is performed based on the threshold. The arithmetic processing unit 70 can be configured to perform no correction operation when the detected value is smaller than or equal to the threshold.

Further, the attitude information detection unit 60 can be a variety of other devices. For example, a camera may be incorporated in the apparatus, and information on a change in the attitude of the wearer may be detected from an image captured with the camera.

Moreover, in the above description, an image is extracted from the light exiting portion B3 by using the fourth reflection surface 21d, which is formed of a single reflection surface. The virtual image display apparatus is not necessarily configured this way but may alternatively be, for example, so configured that an angle conversion section formed of a plurality of reflection surfaces for image extraction is provided and image light fluxes incident on the first reflection surface 21a and the second reflection surface 21b at different angles of incidence are totally reflected different numbers of times before they are extracted. Among the embodiments described above, for example, in the first and second embodiments, which relates to an aspect in which a certain section is physically moved, in the third embodiment, which relates to an aspect in which image processing is performed, and in the fifth embodiment, which relates to an aspect in which the entire optical system is moved, the angle conversion section formed of a plurality of reflection surfaces for image extraction can be used. A conceivable exemplary aspect including the angle conversion section relates to a structure in which the angle conversion section includes a large number of half-silvered mirror layers arranged at equal intervals in parallel to each other and inclined to the first reflection surface 21a and the second reflection surface 21b. In this case, a component of the image light that is incident on the first reflection surface 21a at the greatest angle of reflection and totally reflected off the first reflection surface 21a and the second reflection surface 21b is extracted after the angle of the image light component is converted when it is reflected off a portion of the angle conversion section that is closest to the entrance side (+X side), whereas a component of the image light that is incident on the first reflection surface 21a at the smallest angle of reflection and totally reflected off the first reflection surface 21a and the second reflection surface 21b is extracted after the angle of the image light component is converted when it is reflected off a portion of the angle conversion section that is closest to the far side (−X side). Another conceivable exemplary aspect including the angle conversion section relates to a structure in which the angle conversion section is formed of a large number of reflection units arranged to form stripes and each of the reflection units is formed of a pair of reflection surfaces, a first reflection surface and a second reflection surface inclined to the first reflection surface 21a and the second reflection surface 21b by angles different from each other. In this case, the component of the image light that is incident at the greatest angle of reflection is extracted in a portion of the angle conversion section that is closest to the far side (−X side), whereas a component of the image light that is incident at the smallest angle of reflection is extracted in a portion of the angle conversion section that is closest to the entrance side (+X side). Further, in this case, image light reflected off a single reflection unit is not reflected off the other reflection units but is extracted at a desired angle after only one reflection off the single reflection unit of the angle conversion section.

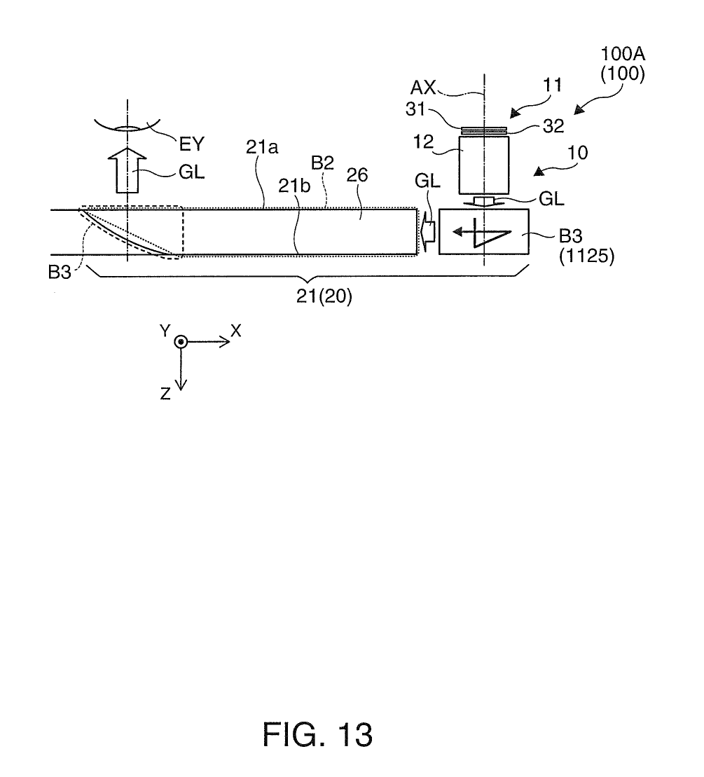

In the above description, in which the light guide section 20 including the light incident portion B1, the light guide portion B2, and the light exiting portion B3 is used in the first embodiment and other embodiments, a flat mirror is not necessarily used in each of the light incident portion B1 and the light exiting portion B3 but a spherically or aspherically curved mirror can be used to provide the light incident portion B1 and the light exiting portion B3 with a lens-like capability. Alternatively, a prism-shaped or block-shaped relay member 1125 separate from the light guide portion 32 can be used as the light incident portion B1 as shown in FIG. 13, and a light incident surface, a light exiting surface, and an inner reflection surface of the relay member 1125 can be configured to have a lens-like capability. Further, the first reflection surface 21a and the second reflection surface 21b, which are provided along the light guide member that forms the light guide portion B2 and reflect image light GL for propagation, are not necessarily parallel to each other but can be curved surfaces.

In the above description, the virtual image display apparatus 100 is assumed to be a head-mounted display for specific description. The virtual image display apparatus 100 can alternatively be modified into a head-up display.

The unpleasant sensation resulting from movement of the image area described above also occurs with a non-see-through-type head-mounted display that blocks environment light, and the attitude information detection unit and the image area position adjustment mechanism shown in any of the embodiments may be used in a non-see-through-type head-mounted display.

In the virtual image display apparatus 100 according to any of the embodiments described above, a set of display apparatus is provided in correspondence with the right and left eyes, but only one of the right and left eyes may be provided, for example, with the image formation section 10 and the light guide section 20 for monocular vision of an image.

When each of the right and left eyes is provided with a display apparatus, appropriate positional adjustment can be made in consideration of the convergence angle and binocular parallax between the positions of the two eyes in 3D image observation.

In the embodiments described above, the first optical axis AX1 passing through the light incident surface IS and the second optical axis AX2 passing through the light incident surface is are parallel to each other, but the optical axes AX1 and AX2 may alternatively not be parallel to each other.

In the embodiments described above, the half-silvered mirror layer 28 provided on the fourth reflection surface 21d of the light guide member 21 has a reflectance of 50% or lower so that the see-through observation has a higher priority, but the half-silvered mirror layer 28 may alternatively have a reflectance of 50% or higher so that the image light observation has a higher priority.

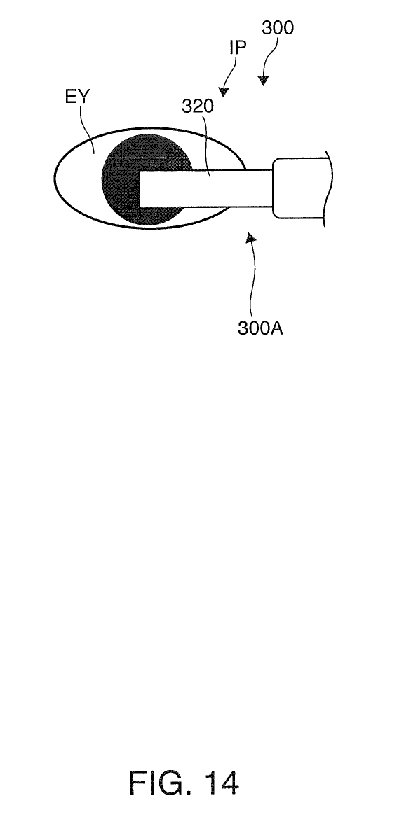

In the embodiments described above, the light guide section 20 in the virtual image formation unit IP is configured to entirely cover a portion in front of the wearer's eye EY, but the virtual image display apparatus is not necessarily configured this way. For example, as a virtual image display apparatus 300 shown in FIG. 14, a small sized display apparatus may be employed, such as a first display apparatus 300A in which a light guide section 320 in a virtual image formation unit IP disposed in correspondence with the position of the eye EY covers only part of the eye EY, that is, covers part of the portion in front of the eye but does not cover the other portions. In this case, the light guide section 320, when it is sufficiently small, is not necessarily a see-through-type section but allows the wearer to view the environment through the area around the light guide section 320. A conceivable specific configuration of the light guide section 320, is described, for example, in JP-A-2010-224473 in detail, which includes an ocular lens (not shown) on the light exiting side.

The entire disclosure of Japanese Patent Application No. 2012-097421, filed Apr. 23, 2012 is expressly incorporated by reference herein.

What is claimed is:

1. A virtual image display apparatus comprising:
a virtual image formation unit that forms a virtual image from image light;
an attitude information detection unit that detects a change in attitude of the head of a wearer who views the virtual image; and
an image area position adjustment mechanism that adjusts an image area position of an image formed of the virtual image formed by the virtual image formation unit based on a detection result from the attitude information detection unit in such a way that the image area position changes in a direction opposite the direction in which the wearer changes the attitude.

2. The virtual image display apparatus according to claim 1,
wherein the virtual image formation unit includes a light modulating device that modulates illumination light from a light source to form image light, a projection system that projects the image light from the light modulating device, and a light guide section that guides the image light from the projection system and outputs the image light to form the virtual image formed by the image light, and
the image area position adjustment mechanism is a movement control mechanism that controls movement of at least one of the light modulating device, the projection system, and the light guide section.

3. The virtual image display apparatus according to claim 2,
wherein the image area position adjustment mechanism is a movement control mechanism that moves the light modulating device relative to the light guide section in a plane parallel to a light incident surface of the light guide section.

4. The virtual image display apparatus according to claim 2,
wherein the image area position adjustment mechanism is a movement control mechanism that moves the projection system relative to the light guide section in a plane parallel to a light incident surface of the light guide section.

5. The virtual image display apparatus according to claim 2,
wherein the image area position adjustment mechanism is a movement control mechanism that rotates the light modulating device and the projection system as a unitary member to incline a projection optical axis of the projection system with respect to a light incident surface of the light guide section.

6. The virtual image display apparatus according to claim 2,
wherein the image area position adjustment mechanism is a modulation control mechanism that controls modulation operation of the light modulating device.

7. The virtual image display apparatus according to claim 1,
wherein the image area position adjustment mechanism is a movement control mechanism that rotates the entire virtual image formation unit.

8. The virtual image display apparatus according to claim 1,
wherein the virtual image formation unit includes a signal light modulation portion that outputs signal light modulated in accordance with an image, a scan system that scans the modulated signal light and outputs the scanned light, and an irradiated member that receives the scanned light from the scan system to form the virtual image formed by the image light, and
the image area position adjustment mechanism is a mechanism that adjusts an irradiation angle of the scanned light from the scan system.

9. The virtual image display apparatus according to claim 1,
wherein the virtual image formation unit transmits environment light and superimposes an environment light image formed by the environment light on the virtual image formed by the image light.

10. The virtual image display apparatus according to claim 1,
wherein the virtual image formation unit covers part of a portion in front of an eye of the wearer.
